(19) United States
(12) Patent Application Publication
(10) Pub. No.: US 2001/0044862 A1
(43) Pub. Date: Nov. 22, 2001

(54) SERIALIZING AND DESERIALING PARALLEL INFORMATION FOR COMMUNICATION BETWEEN DEVICES FOR COMMUNICATING WITH PERIPHERAL BUSES

(76) Inventors: JAMES O. MERGARD, PFLUGERVILLE, TX (US); DAVID F. TOBIAS, PFLUGERVILLE, TX (US)

Correspondence Address: AKIN, GUMP, STRAUSS, HAUER & FELD, 711 LOUISIANA STREET, SUITE 1900 SOUTH, HOUSTON, TX, 77002, US

(21) Appl. No.: 09/208,908

(22) Filed: Dec. 10, 1998

(51) Int. Cl. G06F 3/00; G06F 13/12; G06F 13/38

(52) U.S. Cl. 710/71

(57) ABSTRACT

One disclosed embodiment of the present invention provides a technique for serializing a parallel peripheral bus within a microcontroller. The technique is implemented by converting the parallel data, address, and control information on the parallel peripheral bus to a serial data stream. The serial data stream is then transmitted to an external device. Another embodiment of the present invention provides a technique for receiving a serial data stream from an external device and converting the serial data stream to parallel data, address and control information. The parallel information is then transmitted to the embedded system on the parallel peripheral bus.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

1. Field of the Invention

This invention relates to communication with a microcontroller and more specifically to serial communication with a parallel peripheral bus in an embedded system.

2. Description of the Related Art

The pin count of electronic components within a given electronic system can be a significant limiting factor to decreasing the overall size of that system. In embedded systems, as well as other systems, this has led designers to develop chips with multiple function pins. The functions associated with a particular pin of a component are determined by the application for which the component and, in turn, the embedded system are designed.

Parallel buses have been widely utilized in computer systems. Many microcontrollers have also implemented parallel buses for connecting the embedded system to both internal and external peripherals. When implemented externally, the parallel bus allows a designer to expand the capability of an embedded system.

Serial interfaces have also been widely used in computer systems because of their flexibility. External devices such as plotters, modems, mouses and printers have been designed to transfer or receive information by way of serial interfaces. Data may be transferred serially through a simplex connection, a half-duplex connection, or a full-duplex connection. Utilizing a half-duplex connection both a data terminal equipment (DTE) and a data communications equipment (DCE) can alternatively operate as receiver and transmitter. A variety of high speed serial buses have also been implemented, such as the universal serial bus (USB) and the IEEE 1394 bus.

### SUMMARY OF THE INVENTION

One disclosed embodiment of the present invention provides a technique for serializing a parallel peripheral bus within a microcontroller. The technique is implemented by converting the parallel data, address, and control information on the parallel peripheral bus to a serial data stream. The serial data stream is then transmitted to an external device. Another embodiment of the present invention provides a technique for receiving a serial data stream from an external device and converting the serial data stream to parallel data, address and control information. The parallel information is then transmitted to the embedded system on the parallel peripheral bus.

The parallel peripheral bus of the microcontroller can be multiplexed, with its pins providing other functionality, while at the same time providing for external access to embedded peripherals through the serial bus. This multiplexing technique allows a designer to reduce pin count and at the same time still provide access to external devices.

By serializing the internal system peripheral bus on a microcontroller, a number of options are presented to a designer. If pin count is not critical, the standard parallel bus can still be used to access the internal peripheral bus. If pin count is critical, however, such as if a large number of programmable input/output pins are needed, the designer can employ the serialized bus interface to communicate with external devices and use the pins previously used for the parallel bus for programmable inputs/outputs. Finally, this serialized external bus can be coupled directly to custom chips that also employ an internal serial-to-parallel bus converter, or can be converted to a parallel bus by an external serial-to-parallel converter.

### BRIEF DESCRIPTION OF THE DRAWINGS

A better understanding of the present invention can be obtained when the following detailed description of the preferred embodiment is considered in conjunction with the following drawings, in which:

FIG. 1 is a block diagram of an embedded controller C according to an embodiment of the present invention;

FIG. 2 is a block diagram illustrating a converter according to an embodiment of the present invention;

FIG. 3 is a block diagram illustrating multiple embedded controllers connected through converters according to an embodiment of the present invention; and

FIG. 4 is a block diagram illustrating multiple embedded controllers and external peripherals connected through converters according to an embodiment of the present invention.

### DETAILED DESCRIPTION OF THE PREFERRED EMBODIMENT

### Embedded Controller Overview

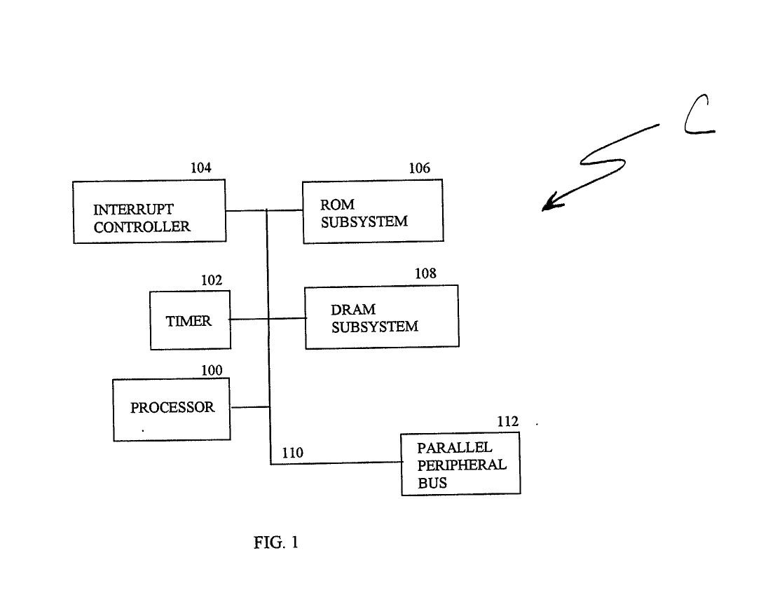

Turning to FIG. 1, illustrated is a block diagram of an embedded controller C according to an embodiment of the present invention. The embedded controller as illustrated includes an internal bus 110 which couples a processor 100 to a timer 102, an interrupt controller 104, a ROM subsystem 106, a DRAM subsystem 108, and a parallel peripheral bus 112. The processor 100 in the disclosed embodiment is compatible with the Am186 instruction set implemented in a variety of microcontrollers manufactured by Advanced Micro Devices Inc. of Sunnyvale, Calif. A variety of other processors could be used instead of the disclosed Am186 instruction set compatible processor 100.

The techniques and circuitry according to the invention could be applied to a wide variety of embedded controllers or microcontrollers. The term “microcontroller” itself has differing definitions in industry. Some companies refer to a processor core with additional features (such as I/O) as a “microprocessor” if it has no onboard memory. Further, digital signal processors (DSPs) are now used for both special and general purpose controller functions. As used herein, the term “microcontroller” covers all of the products, and generally means an execution unit with added functionality all implemented on a monolithic integrated circuit.

As is typical, the timer 102 provides for implementing delays into various routines. The timer 102 can also include a watchdog timer. When incorporated the watchdog timer provides a means of recovery from a system malfunction. In a typical application, if a program fails to reset the watchdog timer within a set interval a hardware reset is initiated. The DRAM subsystem 108 includes a DRAM controller and an appropriate amount of DRAM for the designed application. The ROM subsystem 106 includes an interface to an application appropriate amount of ROM. The ROM can be a flash ROM or an EEPROM.

As is typical of most systems the interrupt controller 104 handles hardware or software interrupts. For example, if an external peripheral is attempting to communicate with the embedded controller C, via the parallel peripheral bus 112, it would normally generate an interrupt. That interrupt request is then handled by the interrupt controller 104. The parallel peripheral bus 112 provides the embedded controller C with access to external peripherals. The parallel peripheral bus 112 can also serve as a link to allow external access to embedded peripherals. For example, the parallel peripheral bus 112 can serve to couple peripherals of the embedded controller C to other external embedded controllers.

### Converter Overview

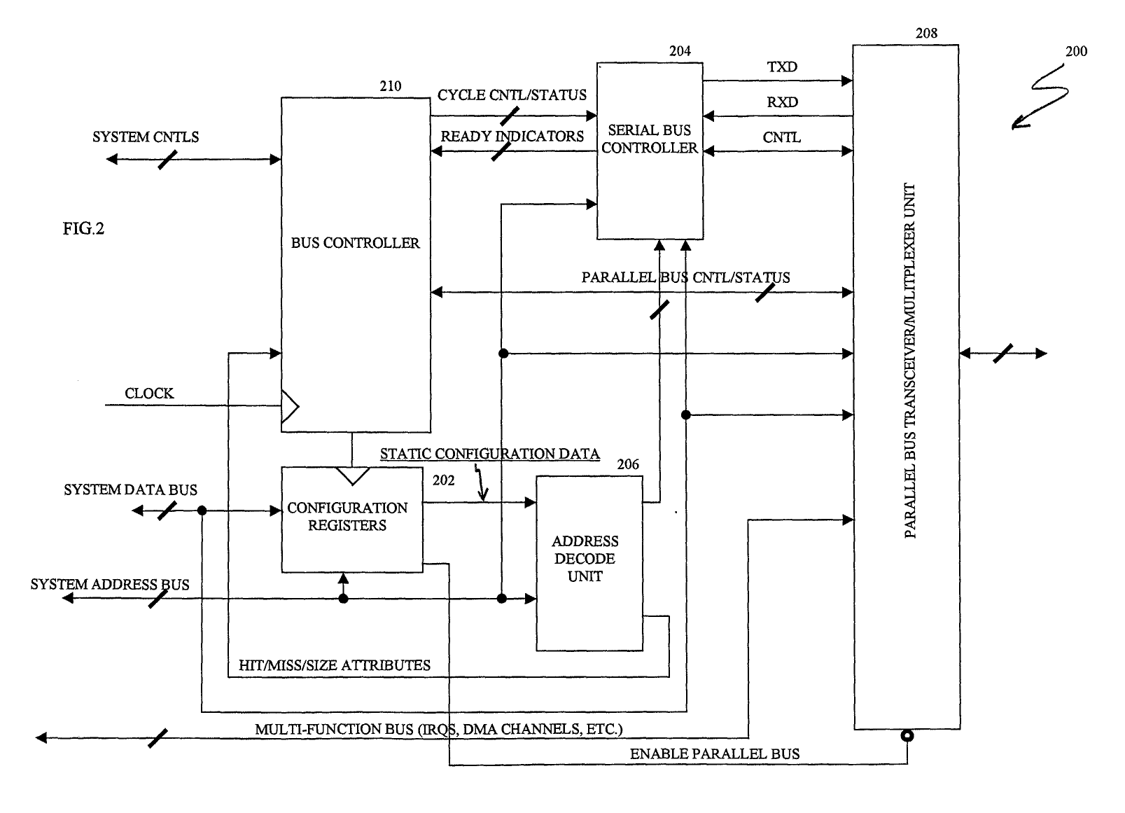

Turning to FIG. 2, a block diagram of a converter 200 according to an embodiment of the present invention is illustrated. The converter 200 provides for a serial bus connection with an external peripheral or an external embedded controller. This serial bus allowed an internal parallel bus of the microcontroller or embedded controller C to be presented externally to the chip in a reduced pin count form. Then, the pins that could be used to access the internal parallel bus can instead be multiplexed and provide other functions, such as programmable input/output pins. The serial bus can then be provided to external peripheral or embedded controller chips which include their own converter, or could instead simply be converted into a parallel bus by an external dedicated chip. In any case, the serialization of the parallel bus provides the designer with greater flexibility in employing pins of the embedded controller.

The converter 200 includes a bus controller 210, a configuration register 202, an address decode unit 206, a serial bus controller 204, and a parallel bus transceiver/multiplexer unit 208. The bus controller 210 receives system controls and a system clock from the embedded controller C. The bus controller 210 provides cycle control and status signals to the serial bus controller 204. The configuration register 202 receives data from a system data bus of the embedded controller C. The configuration register 202 also receives addresses from a system address bus of the embedded controller C. Based upon an address on the system address bus, the configuration register 202 can be set-up to enable or disable the system control, address, and data buses coupled to the parallel bus transceiver/multiplexer unit 208.

The configuration register 202 also provides static configuration data to the address decode unit 206. The static configuration data determines whether data on the system data bus is transferred serially or in parallel. The parallel buses attached to the parallel bus transceiver/multiplexer unit 208 are disabled when data is serially transferred from the embedded controller C to an external peripheral. The signal lines connected to the external peripheral, which are normally associated with the parallel buses, are routed to a multifunction bus. This multifunction bus can provide programmable input/output functions or can provide a variety of other functions, such as UART, interrupt requests, and DMA channels or any number of other desirable features.

The converter 200 serializes all transactions on the parallel peripheral bus for transfer to an external device. If desired, the converter 200 can be set-up such that it has an address or range of addresses (similar to a bridge chip). In this configuration, the converter 200 only serializes transactions directed to a particular address or range of addresses. The converter 200 provides all of the parallel data, address, and control information from the parallel peripheral bus as a serial data stream. In another embodiment the parallel peripheral bus is semi-serialized. In this configuration multiple serial buses (not shown) are utilized to transfer the parallel information.

The bus controller 210 also provides a clock signal to the configuration register 202. The clock signal serves to latch data on the system data bus into the configuration register 202. When the address on the system address bus is that associated with the parallel peripheral bus 112; information on the system bus is serialized. The serial information is then transmitted from the serial bus controller 204 across the parallel bus transceiver/multiplexer unit 208 to an external peripheral or external embedded controller. The serial bus controller 204 operates in half-duplex mode. As previously stated, an advantage of this technique is that the signal lines normally associated with the parallel bus can be used for other functions.

Control and status lines for the parallel bus are routed from the parallel bus transceiver/multiplexer unit 208 to the bus controller 210. The address decode unit 206 is also coupled to the bus controller 210 and provides status information to the bus controller 210. The status information can include whether the address was a hit, a miss or include various size attributes. When an address on the system address bus is that associated with the parallel peripheral bus 112, the address decode unit 206 will decode the address and notify the serial bus controller 204 to receive information from the system bus. The serial bus controller 204 receives the parallel data, address, and control information on the system bus and serializes the information. The information is then transmitted from the serial bus controller 204 through the parallel transceiver/multiplexer unit 208 to an external peripheral.

When parallel information is being transferred from an external peripheral to the embedded controller C through the converter 200 the following transactions occur. The parallel information is received through the parallel bus transceiver/multiplexer unit 208 and is transferred to the serial bus controller 204. The serial bus controller 204 converts the serial information to parallel data, address, and control information. The serial bus controller 204 provides an address on the system address bus for the data that is received. Serial bus controller 204 then provides ready indicators to the bus controller 210. The bus controller 210 then generates system controls on the system control bus, which are directed to a peripheral within the embedded controller C. In this manner, the serial information from the external peripheral is converted to parallel information and placed on the system bus.

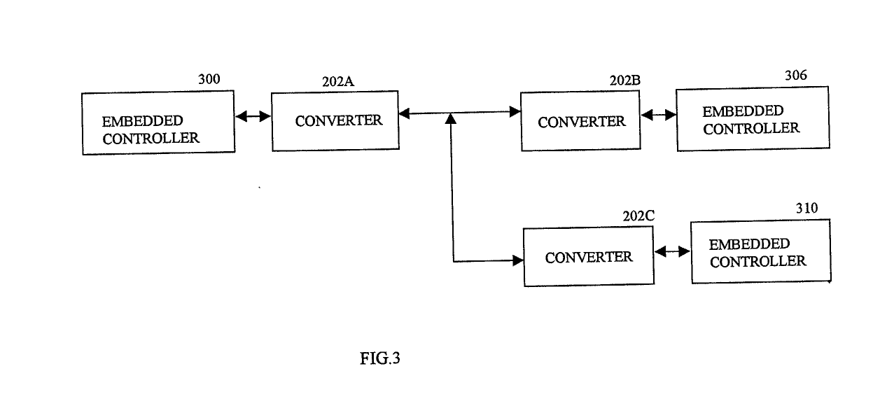

Moving to FIG. 3, shown is a block diagram illustrating multiple embedded controllers 300, 306, and 310 connected through converters 202A, 202B, and 202C according to an embodiment of the present invention. When the embedded controller 300 wishes to transfer information to the embedded controller 306 or 310, the embedded controller 300 transfers the parallel data, address, and control information to the converter 202A. The converter 202A converts the parallel information to serial information and transfers the information over a serial bus to the converters 202B and 202C. When information is directed to the embedded controller 306, the converter 202B converts the serial information to parallel information for use by a peripheral of the embedded controller 306. Likewise, when serial information is directed to the embedded controller 310, the serial converter 202C converts the serial information to parallel information for use by a peripheral of the embedded controller 310. In this manner the embedded controllers 300, 306 and 310 can serially transfer information.

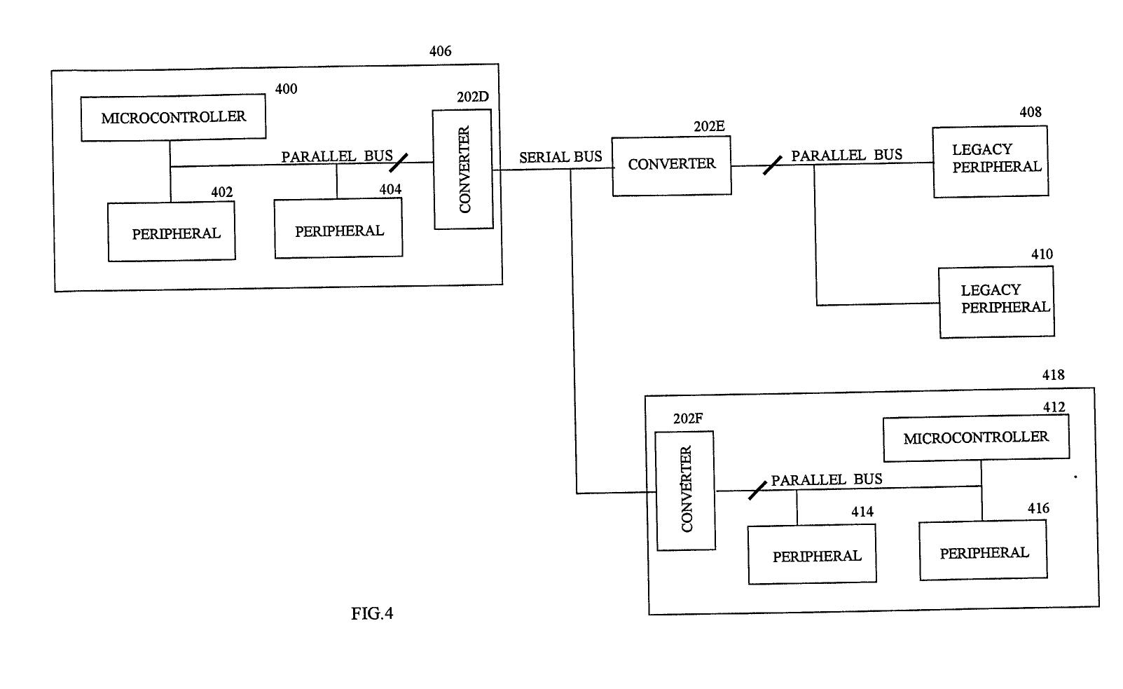

Moving to FIG. 4 illustrated are embedded controllers 406 and 418, converter 202E, and legacy peripherals 408 and 410. The embedded controller 406, as illustrated, includes a microcontroller 400, peripherals 402 and 404, and a converter 202D. The embedded controller 418, as illustrated, includes a microcontroller 412, peripherals 414 and 416, and a converter 202F. The embedded controllers 406 and 418 are coupled to the converter 202E which allows the embedded controllers 406 and 418 to receive serialized parallel information from either of the legacy peripherals 408 and 410. In addition, the embedded controllers 406 and 418 can transfer information between themselves as described above. In contrast to the embedded controllers 300, 306, and 310 of FIG. 3, the embedded controllers 406 and 418 of FIG. 4 are illustrated as having internal converters.

The foregoing disclosure and description of the invention are illustrative and explanatory thereof, and various changes in the size, shape, materials, components, circuit elements, wiring connections and contacts, as well as in the details of the illustrated circuitry and construction and method of operation may be made without departing from the spirit of the invention.

1. A method for selectively providing a serial bus for communication with an embedded system, the embedded system including a parallel peripheral bus, the method comprising the steps of:
converting parallel data, address, and control information on the parallel peripheral bus to a serial data stream containing the parallel data, address, and control information; and
transmitting the serial data stream to an external device.

2. The method of claim 1, wherein the external device is an external peripheral.

3. The method of claim 1, wherein the external device is an external embedded controller.

4. A method for selectively providing a serial bus for communication with an embedded system, the embedded system including a parallel peripheral bus, the method comprising the steps of:
receiving a serial data stream from an external device;
converting the serial data stream to parallel data, address and control information; and
transmitting the parallel data, address and control information to the embedded system over the parallel peripheral bus.

5. The method of claim 4, wherein the external device is an external peripheral.

6. The method of claim 4, wherein the external device is an external embedded controller.

7. A converter for selectively providing a serial bus for communication with an embedded system, the embedded system including a parallel peripheral bus, the converter comprising:
conversion circuitry for converting parallel data, address, and control information on the parallel peripheral bus to a serial data stream containing the parallel data, address, and control information; and
transmission circuitry for transmitting the serial data stream to an external device.

8. The converter of claim 7, wherein the external device is an external peripheral.

9. The converter of claim 7, wherein the external device is an external embedded controller.

10. A converter for selectively providing a serial bus for communication with an embedded system, the embedded system including a parallel peripheral bus, the converter comprising:
reception circuitry for receiving a serial data stream from an external device;
conversion circuitry for converting the serial data stream to parallel data, address, and control information; and
transmission circuitry for transmitting the parallel data, address, and control information to the embedded system over the parallel peripheral bus.

11. The converter of claim 10, wherein the external device is an external peripheral.

12. The converter of claim 10, wherein the external device is an external embedded controller.
